(19) United States
(12) Patent Application Publication
(10) Pub. No.: US 2002/0020786 A1
(43) Pub. Date: Feb. 21, 2002

(54) Device for servo-controlling position, in particular for an aircraft flight control actuator

(76) Inventors: Corinne Gouhier, Deuil la Barre (FR); Genevieve Silvestro, Eragny (FR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/884,530

(22) Filed: Jun. 18, 2001

(30) Foreign Application Priority Data
Jun. 19, 2000 (FR) 00 07794

(51) Int. Cl. B64C 13/50

(52) U.S. Cl. 244/228

(57) ABSTRACT

A position servo-control device comprising at least one servo-control loop and a servo-controlled system placed in said loop, said loop having compensation means which comprise means for filtering at one or more resonant frequencies concerning displacement for the mechanical part(s) of position controlled by the servo-controlled system, the device including compensation means implementing filtering at one or more frequencies constituted by resonant frequencies for the forces exerted on the servo-controlled system and/or on the mechanical parts it controls.

The present invention relates to a device for servo-controlling position, in particular for an aircraft flight control actuator.

### BACKGROUND OF THE INVENTION

Conventionally, a device for servo-controlling position for a flight control actuator comprises a servo-control loop and a servo-controlled system placed in said loop, the loop including compensation means which are disposed therein upstream from the servo-controlled system and which serve in particular to perform filtering at the resonant frequencies of the movements of the mechanical part(s) actuated by said system.

A problem encountered with a servo-control device lies in no account being taken of the forces that act on the mechanical parts that are actuated.

Unfortunately, these forces can be particularly large.

Consequently, it is desirable to be able to control these forces in order to limit the fatigue of the mechanical parts and thus increase their lifetime.

### OBJECTS AND SUMMARY OF THE INVENTION

An object of the invention is to propose a device for servo-controlling position of this kind which is particularly simple and reliable.

To this end, the invention provides a position servo-control device comprising at least one servo-control loop and a servo-controlled system placed in said loop, said loop having compensation means which comprise means for filtering at one or more resonant frequencies concerning displacement for the mechanical part(s) which is (are) position controlled by the servo-controlled system, the device including compensation means implementing filtering at one or more frequencies constituted by resonant frequencies for the forces exerted on the servo-controlled system and/or on the mechanical part(s) it controls.

It will be understood that such a device presents the advantage of making it possible to compensate force without it being necessary to provide additional control means, and in particular without it being necessary to provide force sensors.

It is thus particularly advantageous for control devices in terms of cost, bulk, and weight.

The invention also provides a position servo-control device comprising a plurality of servo-control loops in parallel, each servo-control loop comprising a servo-controlled system and compensation means which include means for filtering at one or more resonant frequencies for displacement of the mechanical part(s) under position control, wherein each loop includes compensation means implementing filtering at one or more frequencies constituted by resonant frequencies for the forces exerted on the servo-controlled system and/or on the mechanical part(s) under position control.

Advantageously, in particular, for each of the loops it includes means for estimating the force exerted on the mechanical means as a function of the signal, and it also includes means for deducing a mean force estimate from the various force estimates obtained in this way, and means which, for each of the loops, correct an input of a compensation module performing filtering at one or more frequencies which are resonant frequencies for the forces exerted on the mechanical part(s) under position control, said correction being a function of an error signal characteristic of the difference between the force estimate of the loop and the mean force estimate.

The devices proposed by the invention are particularly advantageous for applications in aviation, in particular for aircraft flight control actuators.

They can also advantageously be applied to servo-controlling load actuators of test benches.

### BRIEF DESCRIPTION OF THE DRAWINGS

Other characteristics and advantages of the invention appear further from the following description which is purely illustrative and non-limiting and which should be read with reference to the accompanying drawings, in which:

FIG. 1 is a diagram showing a device constituting one possible embodiment of the invention; and

FIG. 2 is a diagram showing a device constituting another possible embodiment of the invention.

### MORE DETAILED DESCRIPTION

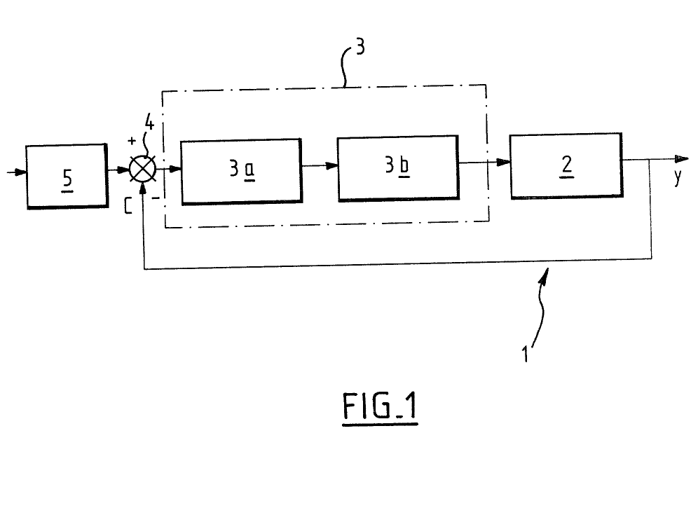

The device shown in FIG. 1 comprises a servo-control loop 1, a servo-controlled system 2, and compensation means 3 which are disposed upstream from these convergence means.

The subtraction means at the inlet to the loop that receive a control signal C and that subtract therefrom the control signal “y” for controlling position at the outlet from the loop to generate an error signal, are referenced 4.

FIG. 1 also shows a filter 5 which receives a non-filtered control signal at its input and which outputs the signal C.

The compensation means 3 perform filtering in particular at frequencies which are resonant frequencies for the movements of the various parts of the servo-controlled system (position compensation module 3a).

They also perform filtering at frequencies which are resonant frequencies for forces exerted on the servo-controlled system and/or the mechanical parts actuated by said system (force compensation module 3b).

In the example shown in FIG. 1, these two stages of filtering are performed in two successive modules 3a and 3b corresponding to two filter functions centered on different frequencies.

In a variant, they could be implemented in a single, common module.

Naturally, the device shown in FIG. 1 assumes a priori knowledge about the force behavior of the servo-controlled system and of the mechanical parts it actuates.

Such a priori knowledge is obtained by testing the force behavior of the servo-controlled system and of the mechanical parts.

For an aircraft flight control, and in particular a hydraulic control, or indeed for a load actuator on a flight control test bench, this frequency range extends from zero to the sampling frequency of the controller, which is generally 100 Hz to 200 Hz.

In this range, the frequency range 0 to 12 Hz or 15 Hz is the most sensitive.

In the absence of force compensation in the servo-control loop, the forces at force resonant frequencies can go beyond the stop load of the actuator or the servo-control, which stop load can be several tens of (metric) tonnes.

The force behavior filtering implemented by the compensation means 3 can be of various types: filters with a plurality of cutoff holes, lowpass filters, etc.

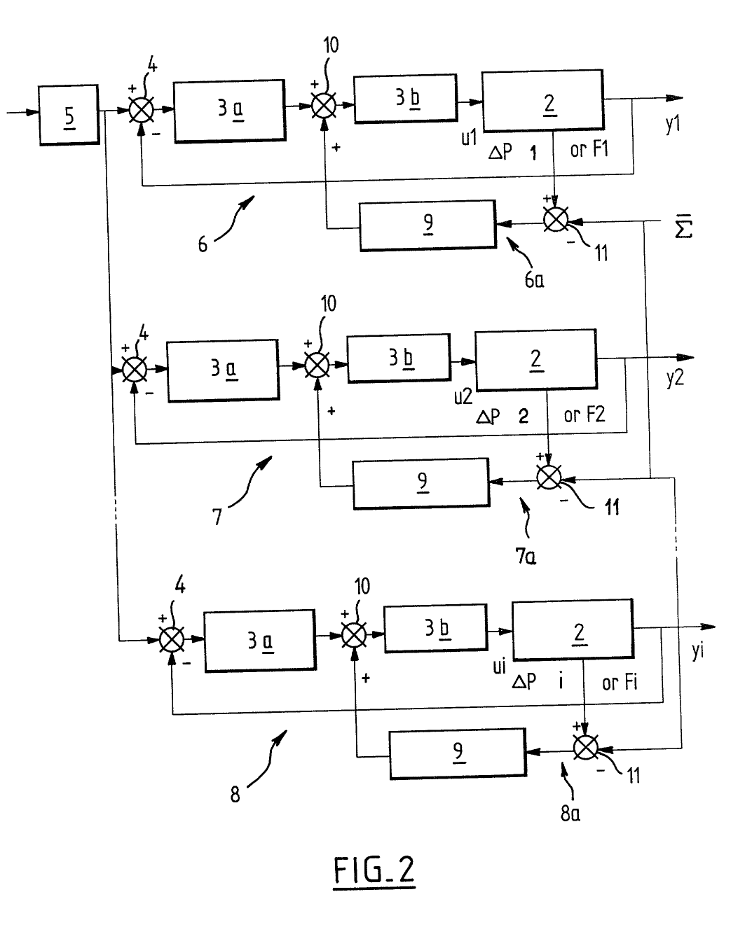

FIG. 2 shows an embodiment in which a plurality of servo-control loops of the type shown in FIG. 1 and referenced 6, 7, and 8 in this case, are connected in parallel to provide control redundancy.

Each of these three loops comprises, upstream from a servo-controlled system 2, a position compensation module 3a and a force compensation module 3b.

A filter 5 common to all three paths applies the same filtered control signal C to the three loops 6 to 8.

The servo-controlled systems 2 have means for defining a signal that corresponds to an estimated force (force Fi, pressure difference ΔPi, torque, . . . ) on the actuated mechanical means (“yi” designating the signal characterizing position in the ith loop).

The force estimate signal determined for a servo-controlled system is averaged with the force estimate signals output by the other servo-controlled systems.

The resulting mean signal \overline{Σ} is subtracted (means 11) from the force estimate signal obtained in each of the loops.

The resulting error signal is used for generating a correction signal obtained by processing by means of a transfer function 9. This correction signal is summed (means 10) with the signal output from the position compensation module 3a so as to obtain a corrected signal at the input to the force compensation module 3b.

The internal loops 6a, 7a, and 8a, set up in this way thus advantageously replace the synchronization system which would otherwise need to be provided to enable the various loops 6, 7, and 8 to operate in parallel.

In a variant, these internal loops can be associated with a synchronization system whose load they reduce.

1. A position servo-control device comprising at least one servo-control loop and a servo-controlled system placed in said loop, said loop having compensation means which comprise means for filtering at one or more resonant frequencies concerning displacement for the mechanical part(s) which is (are) position controlled by the servo-controlled system, the device including compensation means implementing filtering at one or more frequencies constituted by resonant frequencies for the forces exerted on the servo-controlled system and/or on the mechanical part(s) it controls.

2. A position servo-control device comprising a plurality of servo-control loops in parallel, each servo-control loop comprising a servo-controlled system and compensation means which include means for filtering at one or more resonant frequencies for displacement of the mechanical part(s) under position control, wherein each loop includes compensation means implementing filtering at one or more frequencies constituted by resonant frequencies for the forces exerted on the servo-controlled system and/or on the mechanical part(s) under position control.

3. A device according to claim 2, wherein, for each of the loops, it includes means for estimating the force exerted on the mechanical means as a function of the signal, and it also includes means for deducing a mean force estimate from the various force estimates obtained in this way, and means which, for each of the loops, correct an input of a compensation module performing filtering at one or more frequencies which are resonant frequencies for the forces exerted on the mechanical part(s) under position control, said correction being a function of an error signal characteristic of the difference between the force estimate of the loop and the mean force estimate.

4. A position servo-control device for an aircraft flight control actuator, the device being constituted by a device according to claim 1.

5. A position servo-control device for a test bench load actuator, the device being constituted by a device according to claim 1.
